(19) United States
(12) Patent Application Publication
(10) Pub. No.: US 2015/0197345 A1
(43) Pub. Date: Jul. 16, 2015

(54) OBJECT DEFLECTION DEVICE AND PROTECTION UNIT

(71) Applicant: Rob Abbinante, Chicago, IL (US)

(72) Inventor: Rob Abbinante, Chicago, IL (US)

(21) Appl. No.: 14/593,497

(22) Filed: Jan. 9, 2015

Related U.S. Application Data
(60) Provisional application No. 61/927,137, filed on Jan. 14, 2014.

(51) Int. Cl. B64D 45/00; H01Q 1/42; H01Q 1/28

(52) U.S. Cl. CPC B64D 45/00; H01Q 1/288; H01Q 1/42

(57) ABSTRACT

An object deflection unit comprising a deflection unit having an adapting plate and a top surface, a plurality of doubler units affixed to an aircraft frame, where the deflection unit is secured to the aircraft frame via the securing flange and doubler units.

### RELATED APPLICATIONS

This application is a non-provisional application that claims the benefit of and the priority from U.S. Provisional Application No. 61/927,137 filed Jan. 14, 2014, titled “Object Deflection Device and Protection Unit”.

### BACKGROUND OF THE INVENTION

Airline passengers today are demanding to be connected to the ground via wireless Internet (“WiFi”) while in flight. However, one of the challenges to providing satellite based Internet is obtaining the required certification of an object strike prevention system that complies with United States Federal Aviation Administration (“FAA”) regulations. Large satellite antennas on aircraft are incapable of sustaining impact from an object in flight. Therefore, a need exists for a system to prevent objects from striking satellite systems on an aircraft in flight that is also compliant with FAA regulations.

### SUMMARY OF THE INVENTION

One embodiment of the present invention includes an object deflection unit comprising a deflection unit having an adapting plate and a top surface, and a plurality of doubler units affixed to an aircraft frame, where the deflection unit is secured to the aircraft frame via the securing flange and doubler units.

In another embodiment, the deflection unit may be made of a elastic and transmissive material.

In another embodiment, he deflection unit is made of a material capable of absorbing the impact of a bird in flight.

In another embodiment, the deflection unit may include an interior cavity.

In another embodiment, the interior cavity of the deflection unit may be substantially filled with a shock absorbent foam.

In another embodiment, the foam may be a visio-elastic polymer.

In another embodiment, a lower surface of the deflection unit may have a substantially arced shape.

In another embodiment, a largest diameter of the arc of the lower surface may be greater than the largest diameter of a cover unit adjacent the deflection unit.

In another embodiment, the cover unit may cover a wireless transmission device on an aircraft.

In another embodiment, the height of top surface may be sized such that it does not significantly interfere with transmissions of the wireless transmission device.

Another embodiment of the present invention includes a method of deflecting an object from impacting a cover unit on an aircraft including the steps of securing internal attachment units to the formers of an aircraft frame, positioning a deflection unit having a top surface on a upwind side of a cover unit secured to the skin of an aircraft, securing the deflection unit to an adapting plate, securing the deflecting plate to doubler units, and securing the doubler units to the internal attachment units through the skin of the aircraft.

In another embodiment, the deflection unit may be made of a elastic and transmissive material.

In another embodiment, he deflection unit is made of a material capable of absorbing the impact of a bird in flight.

In another embodiment, the deflection unit may include an interior cavity.

In another embodiment, the method may include the step of substantially filling the interior cavity of the deflection unit with a shock absorbent foam.

In another embodiment, the foam may be a visio-elastic polymer.

In another embodiment, a lower surface of the deflection unit may have a substantially arced shape.

In another embodiment, a largest diameter of the arc of the lower surface may be greater than the largest diameter of the cover unit adjacent the deflection unit.

In another embodiment, the cover unit may cover a wireless transmission device on an aircraft.

In another embodiment, the height of top surface may be sized such that it does not significantly interfere with transmissions of the wireless transmission device.

### BRIEF DESCRIPTION OF THE DRAWINGS

FIG. 1 depicts a perspective view of an object deflection system that is consistent with the present invention;

FIG. 2 depicts a front view of the object deflection system of FIG. 1;

FIG. 3 depicts a side view of the object deflection system of FIG. 1;

FIG. 4 depicts a top view of the object deflection system of FIG. 1;

FIG. 5A depicts another embodiment of an object deflection system;

FIG. 5B depicts a side view of the deflection unit of FIG. 5A;

FIG. 5C depicts a top view of the object deflection system of FIG. 5A;

FIG. 5D depicts a front view of the object deflection system of FIG. 5A; and

FIG. 6 depicts a break away view of an object deflection system mounted to an aircraft.

### DETAILED DESCRIPTION OF THE INVENTION

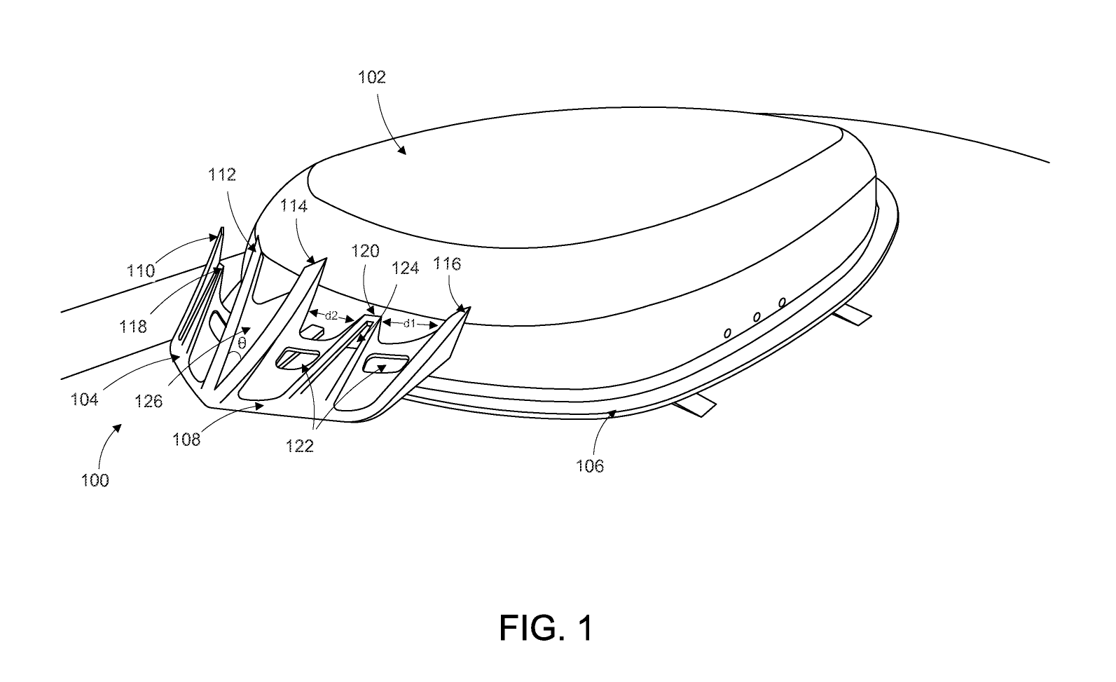

FIG. 1 depicts a perspective view of an object deflection system 100 that is consistent with the present invention. The object deflection system 100 includes a cover unit 102 and a deflection unit 104. The cover unit 102 may be substantially elliptical in shape when viewed from above. Alternatively, the cover unit 102 may be substantially teardrop shaped when viewed from above. In another embodiment, the cover unit 102 is substantially circular shaped. In one embodiment, the cover unit 102 is a radome that is used to protect a satellite antenna on an aircraft.

The deflection unit 104 includes a base portion 108 and outer extension units 110 and 116, inner extension units 118 and 120, and central extension units 112 and 114 that extend from the upper side of the base portion 108. Outer extension units 110 and 116 are positioned on opposite side edges of the base portion 108 and have a top surface that angles towards the center of the base portion 108. Central extension units 112 and 114 are substantially V shaped and are separated by an angle θ with reference to the centerline of each central extension unit 112 and 114. Inner extension units 118 and 120 are substantially U shaped with inner extension unit 118 being positioned between outer extension unit 110 and central extension unit 112, and inner extension unit 120 being positioned between central extension unit 114 and outer extension unit 116. The base portion 108 may also include openings 122 positioned between each extension unit 110, 112, 114, 118 or 120. A portion of the inner extension units 118 and 120 may also include an opening 124. The deflection unit 104 is made of an elastic, transmissive material capable of absorbing the impact of approximately 20,000 to 40,000 lbs such as, but not limited to, carbon fiber or Kevlar.

The area between the central extension units 112 and 114 may include a concave portion 126 that extends from the back of the deflection unit 104 towards the cover unit 102. The concave portion 126 may be angled from the central extension units 112 and 114 towards the cover unit 102 by a predetermined angle. The surface of the concave portion 126 may be smooth to allow air to flow over the concave portion with minimal air resistance.

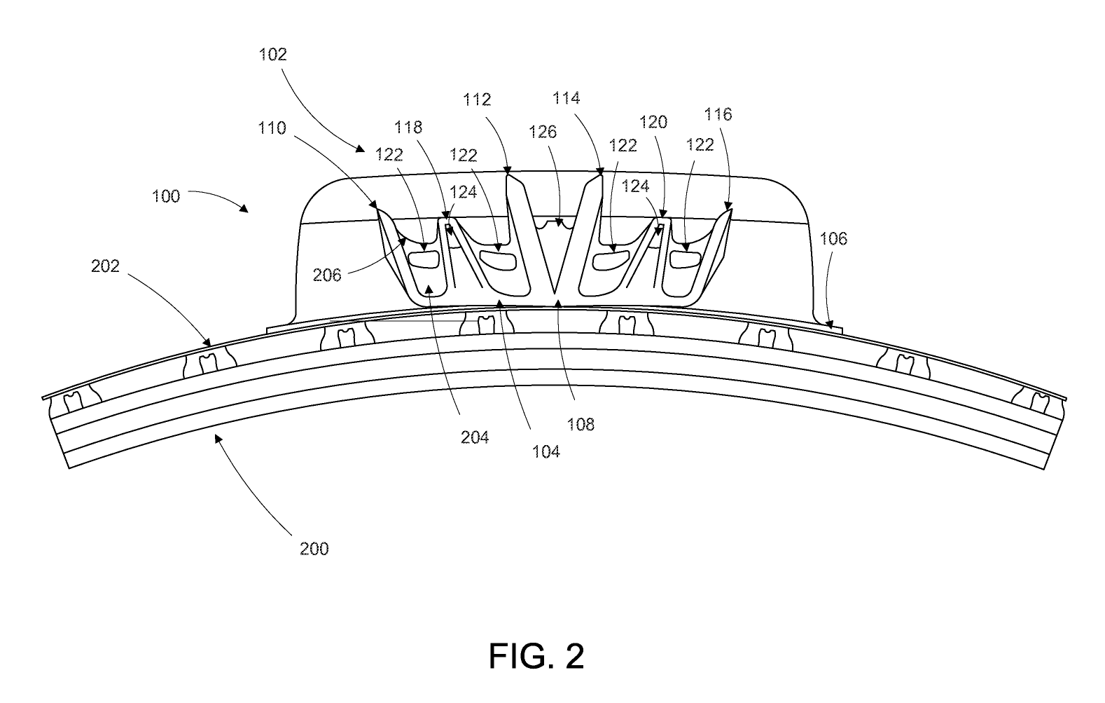

FIG. 2 depicts a front view of the object deflection system 100. The outer extension units 110 and 116 are each separated from the inner extension units 118 and 120 by a distance (d1), and the central extension units 112 and 114 are each separated from the inner extension units 118 and 120 by a distance (d2). In one embodiment, the distance d1 is larger than the distance d2. In another embodiment, the distance d2 is larger than the distance d1. In yet another embodiment, the distance d1 is approximately equal to the distance d2.

The sides of the extension units 110, 112, 114, 116, 118 and 120 are connected by connection portions 204. The upper edges 206, of the connection portions 204 are substantially arc shaped with the top surface of the connection portions 204 having a substantially smooth surface. The connection portions 204 may connect the back sides of the extension units 110, 112, 114, 116, 118 and 120 together.

The outer extension units 110 and 116 are positioned at the side edges of the base portion 108 and are shorter in length than the central extension units 112 and 114. The central extension units 112 and 114 are substantially V shaped when viewed from the front and are separated by an angle θ. The central extension units 112 and 114 are longer in length than the outer extension units 110 and 116 and the inner extension units 118 and 120. The inner extension units 118 and 120 are substantially U shaped with the portion of the inner extension units 118 and 120 closest to the base portion 108 being wider than the portion furthest from the base portion 108. The top surface of each inner extension unit 118 and 120 is substantially flat. The lower surfaces of the base portion 108 and cover unit 102 are configured to conform to the shape of the surface 202 of the structure 200.

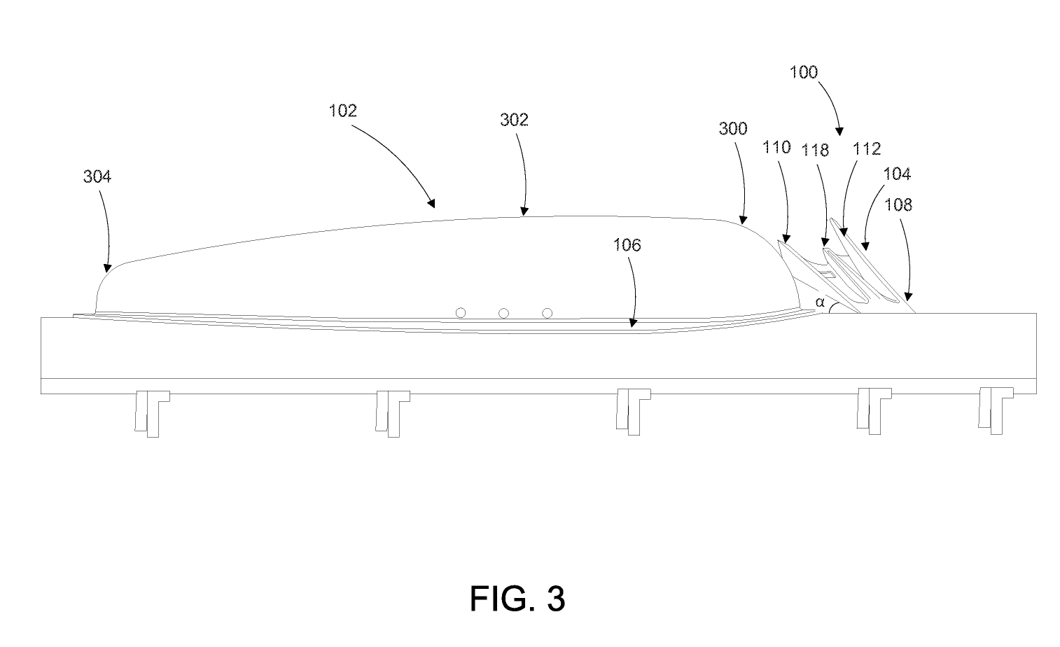

FIG. 3 depicts a side view of the object deflection system of FIG. 1. The front end 300 of the cover unit 102, the end of the cover unit 102 closest to the deflection unit 104, has a substantially curved shape to create an aerodynamic form that provides minimal resistance to air flowing over the surface of the cover 102. The top surface 302 of the cover unit 102 slopes from the front end 300 to the back end, the end furthest from the deflection unit 103, with the back end being substantially curved from the top surface 302 to the surface 202 of the structure.

The deflection unit 104 is angled towards the cover unit 102 at an angle a such that the outer surface of the deflection unit 104 deflects objects striking the deflection unit 104 above the cover unit 102. In one embodiment, the deflection unit 104 is angled towards the front end 200 of the cover such that the top surface of the deflection unit 104 has a shallower angle than the angle of curvature of the front end 300 of the cover unit 102. In one embodiment, the outer extension units 110 and 116 are angled from the surface 202 at a first angle, the central extension units 112 and 114 are angled from the surface 202 at a second angle, and the inner extension units 118 and 120 are angled from the surface 202 at a third angle. In one embodiment the first, second and third angles are different values. In another embodiment, the first, second and third angles are approximately the same value.

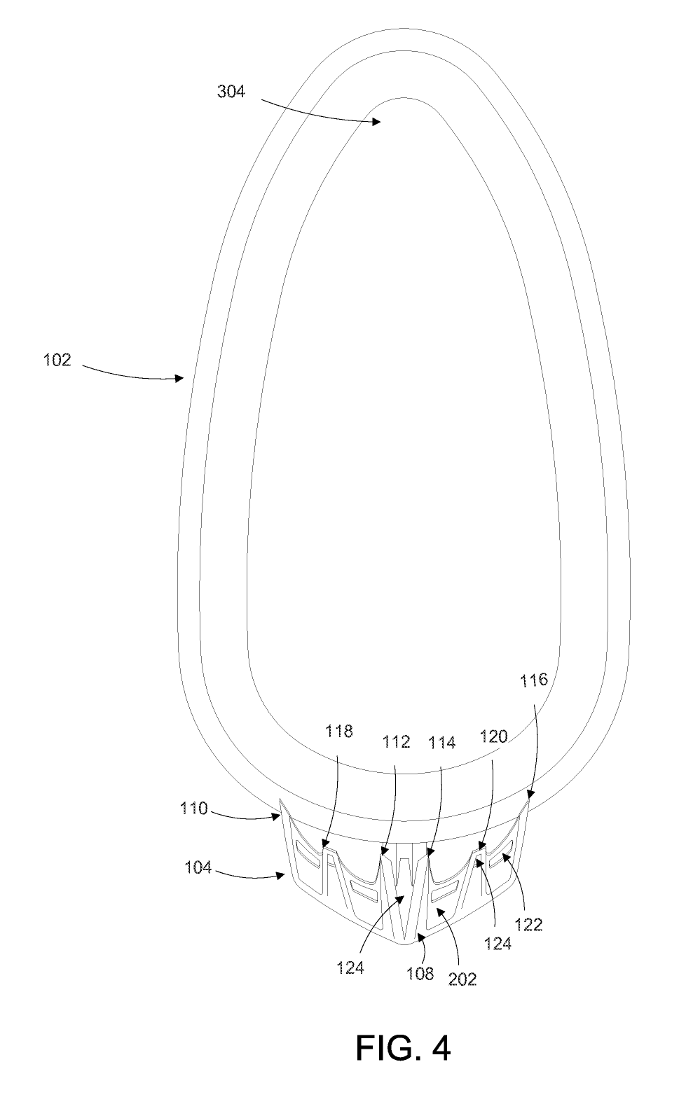

FIG. 4 depicts a top view of the object deflection system of FIG. 1. The base portion 108 is substantially V shaped with the lower ends of the central extension units 112 and 114 converging at the central axis of the base portion 108. The outer extension units 110 and 116 are closer in proximity to the cover unit 102 than the central extension units 112 and 114. In one embodiment, the central axis of the deflection unit 104 is substantially aligned with the central axis of the cover unit 102. In another embodiment, the central axis of the deflection unit 104 is offset from the central axis of the cover unit 102. In one embodiment, the deflection unit 104 is separated from the cover unit 102 by a predetermined distance. In another embodiment, the deflection unit 104 is incorporated into the cover unit 102. In one embodiment, the deflection unit 104 is secured to the structure by two connection tabs 402. The connection tabs 402 may extend from the lower portion of the base unit 108 towards the cover unit 102.

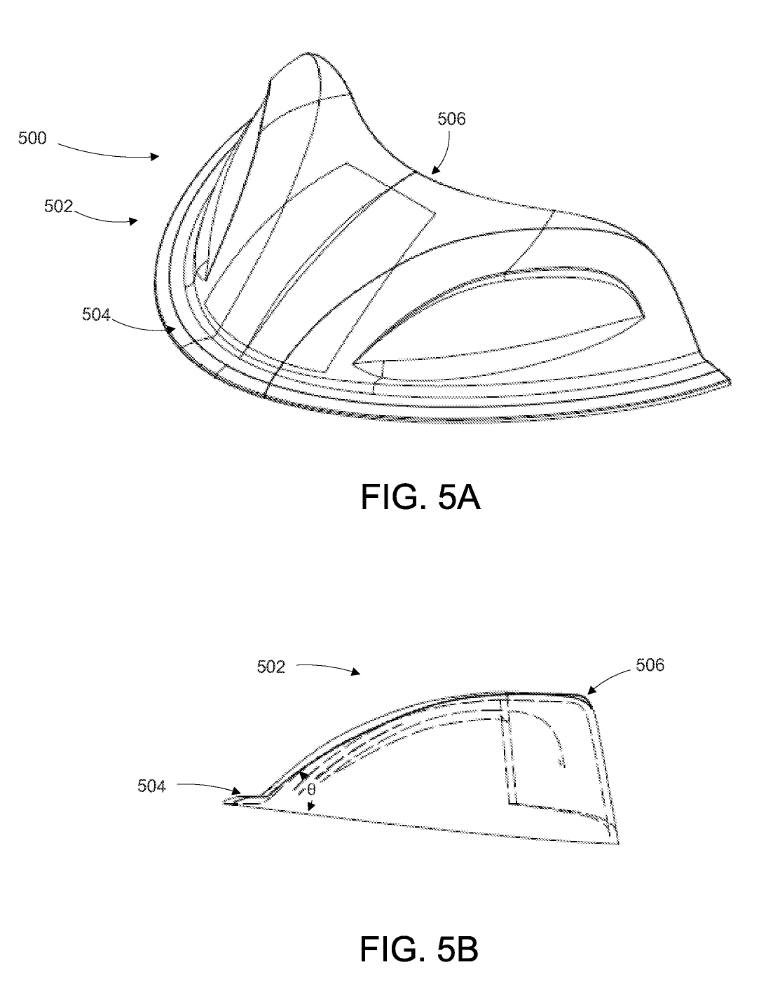

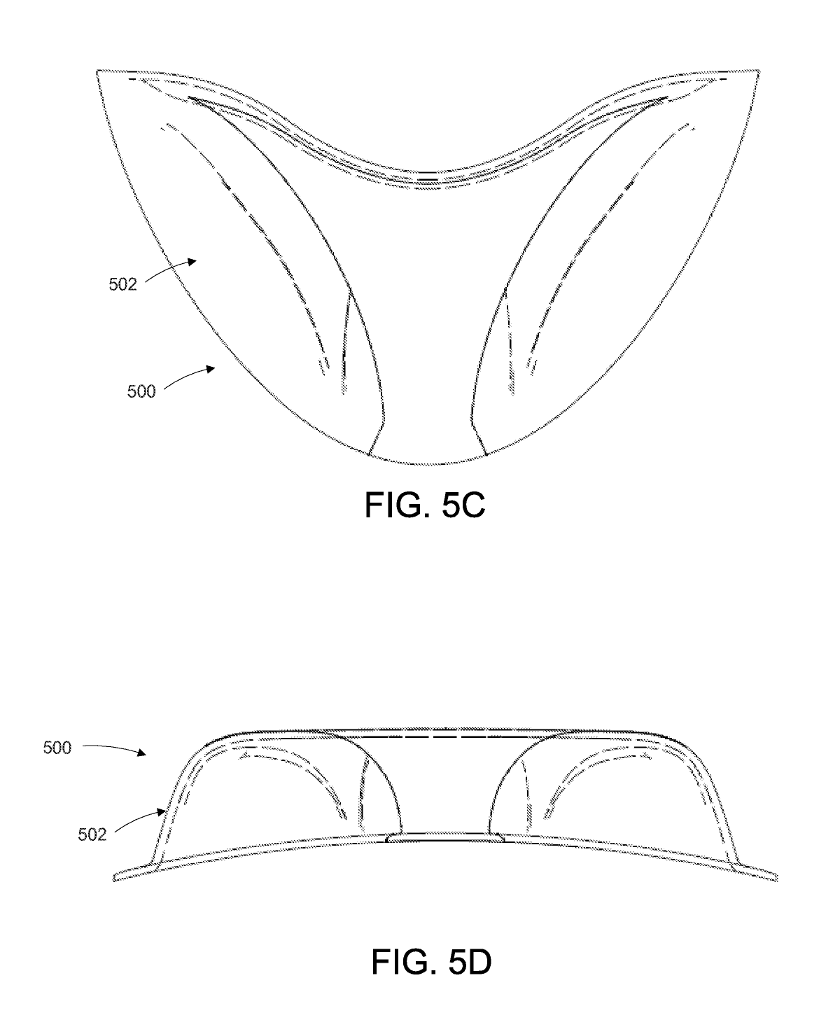

FIG. 5A depicts another embodiment of an object deflection system 500. The object deflection system 500 includes a deflection unit 502 and a adapting plate 504. The deflection unit 502 is made of an elastic, transmissive material capable of absorbing an impact of approximately 20,000 to 40,000 lbs such as, but not limited to, carbon fiber or Kevlar. The interior portion of the deflection unit 502 may be filled with a force absorbing foam such as a visco-elastic polymer or any other foam capable of adsorbing the impact of an object during flight. The plate 504 defines a lower surface that is substantially arc shaped. In one embodiment, the diameter of the arc shaped plate 504 is greater than the largest diameter of the cover unit positioned behind the deflection unit 502. The top surface of the deflection unit 502 extends from the lower surface formed by the plate 504 to a top edge 506 of the deflection unit 502. The top surface of the deflection unit 502 may be formed such that the drag caused by the installation of the deflection unit 502 is minimized. The top edge 506 of the deflection unit 502 may extend to a height that does not significantly interfere with the signals transmitted and received by the antenna in the cover unit positioned behind the top surface 506 of the cover 502.

FIG. 5B depicts a side view of the deflection unit 502. The top surface of the cover extends from the plate 504 to the top surface 506 at an angle θ such that an object striking the top surface of the deflection unit 502 is deflected away from the deflection unit 502. In one embodiment, the angle θ is between approximately 20 degrees and approximately 30 degrees. The top surface 506 of the deflection unit 502 has a height that is at least substantially equal to the height of the cover unit positioned behind the top surface 506 of the deflection unit 502. FIG. 5C depicts a top view of the object deflection system 500. FIG. 5D depicts a front view of the object deflection system 500.

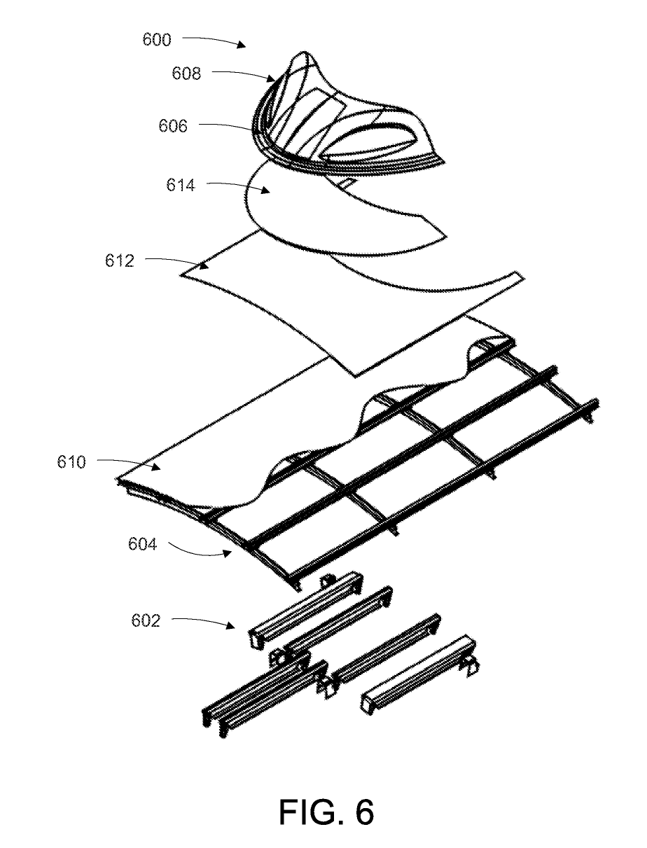

FIG. 6 depicts a break away view of an object deflection system 600 mounted to an aircraft. Internal attachment units 602 are affixed between the formers 604 of the aircraft frame using any known securing method including riveting or welding with the ends of the internal attachment units 602 being affixed to a portion of each formers 604. The internal attachment units 602 may be manufactured from any rigid material including steel, titanium, aluminum, carbon fiber, or any other rigid material. The internal attachment units 602 are secured to the aircraft frame such that the object deflection unit 600 does not detach from the aircraft after impact of an object.

The internal attachment units 602 are positioned between the formers 604 such that the plate 606 on the deflection unit 608 of the object deflection system 600 can be secured to the internal attachment units 602 when the deflection unit 608 is affixed to the aircraft. A first layer 610 of aircraft skin is affixed to the formers 604 and internal attachment units 602 below the location where the deflection unit 608 is affixed to the aircraft. Securing doubler units 612 and 614 of aircraft skin may be secured to the first layer 610 of aircraft skin between the plate 606 of the cover 608 and the first layer of aircraft skin 610. The plate 606 may be secured to the securing doubler units 610, 612, ad 614 and the securing doubler units 602 using any known securing method including rivets, screws, adhesives, welding or any other securing method. The plate 606 may be sealed to the skin 610 to form an air tight barrier after the cover 608 is installed on the aircraft.

It is to be understood that both the foregoing general description and the following detailed description are exemplary and are intended to provide further explanation of the invention claimed. The disclosed configuration is the preferred embodiment and is not intended to preclude functional equivalents to the various elements.

The accompanying drawings, which are incorporated in and constitute part of this specification, are included to illustrate and provide a further understanding of the invention. Together with the description, the drawings serve to explain the principles of the invention.

1. An object deflection unit comprising:
a deflection unit having an adapting plate and a top surface;
a plurality of doubler units affixed to an aircraft frame;
wherein the deflection unit is secured to the aircraft frame via the securing flange and doubler units.

2. The object deflection unit of claim 1 wherein the deflection unit is made of a elastic and transmissive material.

3. The object deflection unit of claim 2 wherein he deflection unit is made of a material capable of absorbing the impact of a bird in flight.

4. The object deflection unit of claim 1, wherein the deflection unit includes an interior cavity.

5. The object deflection unit of claim 4 wherein the interior cavity of the deflection unit is substantially filled with a shock absorbent foam.

6. The object deflection unit of claim 5 wherein the foam is a visio-elastic polymer.

7. The object deflection unit of claim 1 wherein a lower surface of the deflection unit has a substantially arced shape.

8. The object deflection unit of claim 6 wherein a largest diameter of the arc of the lower surface is greater than the largest diameter of a cover unit adjacent the deflection unit.

9. The object deflection unit of claim 8 wherein the cover unit covers a wireless transmission device on an aircraft.

10. The object deflection unit of claim 9 wherein the height of top surface is sized such that it does not significantly interfere with transmissions of the wireless transmission device.

11. A method of deflecting an object from impacting a cover unit on an aircraft including the steps of:
securing internal attachment units to the formers of an aircraft frame;
positioning a deflection unit having a top surface on a upwind side of a cover unit secured to the skin of an aircraft;
securing the deflection unit to an adapting plate;
securing the deflecting plate to doubler units; and
securing the doubler units to the internal attachment units through the skin of the aircraft.

12. The method of claim 11 wherein the deflection unit is made of a elastic and transmissive material.

13. The method of claim 12 wherein the deflection unit is made of a material capable of absorbing the impact of a bird in flight.

14. The method of claim 11, wherein the deflection unit includes an interior cavity.

15. The method of claim 14 including the step of substantially filling the interior cavity of the deflection unit with a shock absorbent foam.

16. The method of claim 15 wherein the foam is a visio-elastic polymer.

17. The method of claim 11 wherein a lower surface of the deflection unit has a substantially arced shape.

18. The method of claim 16 wherein a largest diameter of the arc of the lower surface is greater than the largest diameter of the cover unit adjacent the deflection unit.

19. The method of claim 11 wherein the cover unit covers a wireless transmission device on an aircraft.

20. The method of claim 19 wherein the height of top surface is sized such that it does not significantly interfere with transmissions of the wireless transmission device.
